(19) United States
(12) Patent Application Publication
(10) Pub. No.: US 2026/0187739 A1
(43) Pub. Date: Jul. 2, 2026

(54) SYSTEMS AND METHODS FOR BASIS AVOIDANCE FOR ENERGY GENERATION SITES

(71) Applicant: Inventus Holdings, LLC, Juno Beach, FL (US)

(72) Inventors: Nicole P. Cortes, Juno Beach, FL (US); Lauren A. Foley, Juno Beach, FL (US); Lenard A. Smith, Juno Beach, FL (US); David W. Abel, Juno Beach, FL (US); Joshua M. Felton, Juno Beach, FL (US)

(21) Appl. No.: 19/007,275

(22) Filed: Dec. 31, 2024

(51) Int. Cl. G06Q 50/06; G06Q 40/04

(52) U.S. Cl. CPC G06Q 50/06; G06Q 40/04

(57) ABSTRACT

The disclosed technology includes systems and methods for avoiding basis risk by generating variable offer prices for sale of electricity at energy generation sites. The method can include determining a forecasted real-time locational marginal price (RTLMP) for an energy generation site. The method can include generating an offer price for sale of electricity generated by the energy generation site. The method can include posting the offer price in an offer portal. The offer price can be based at least in part on the forecasted RTLMP and one or more agreement parameters. In some embodiments, the offer price can be configured to reduce a basis risk if the offer price clears a market price. That is, in some embodiments, the offer price can clear the market price only if a sum of the one or more agreement parameters is greater than the basis risk.

### FIELD OF THE DISCLOSURE

The various embodiments of the present disclosure relate generally to systems and methods of avoiding basis risk in renewable energy transactions, and more particularly to algorithms for generating offer prices configured to avoid basis risk in renewable energy transactions.

### BACKGROUND

Parties of energy transactions, particularly renewable energy transactions, are often exposed to basis risk. Basis risk can be defined as the difference in a locational marginal price (LMP) between a generation location and a customer, or offtaker, location. Parties of some renewable energy transactions may have a power purchase agreement (PPA), outlining the price per unit of energy, typically in dollars per megawatt hour ($/MWh), that the offtaker is to pay to the renewable energy generator for a set amount of energy over a period of time. The price in some PPAs is fixed, and in some PPAs the price can be variable. In some PPAs with variable pricing, the price can be based heavily on a hub price.

A hub price is a weighted average of node prices in a select region, where the node prices are the price of electricity, or LMP, at the specific node. As can be appreciated, the node price and a corresponding hub price may vary. Additionally, the offtaker may be located in a different geographic region, or hub, than the generator, thus causing the node price for the generator to vary from the hub price of the offtaker. For a PPA, a correlation in variation between the generator's node price and the offtaker's hub price can allow the parties to build the difference between the two prices into the price set in the PPA. However, if the generator's node price varies differently from, or does not correlate with, the offtaker's hub price, one of the parties can be at risk of owing the difference, or the basis risk, between the prices.

Further, the price for electricity at each node is determined by an independent system operator (ISO). At each node, the ISO receives bids from energy generating sites, and may use a system of clearing the prices to determine the node price at a given time. The node price output by the ISO may also be referred to as the LMP of that node. This process may be completed at time intervals throughout a day, such as every 5 minutes, every 15 minutes, every 30 minutes, etc. After receiving bids, the ISO determines the node price by selecting a highest marginal price, also known as a “market clearing price” to meet the electricity demands at the corresponding node. All generators who offered bids at a lower price than the market clearing price will receive the market clearing price, and generators who offered at a higher price than the market clearing price must curtail output to meet the demand requirements of the market clearing price.

Traditional solutions for basis risk avoidance include augmenting PPAs and purchasing forward hedge products or similar market instruments.

Accordingly, there is a need for improved systems and methods for avoiding basis risk for energy generation sites. Embodiments of the present disclosure are directed to this and other considerations.

### BRIEF SUMMARY

An exemplary embodiment of the present disclosure provides a method for generating variable offer prices for sale of electricity at energy generation sites including determining a forecasted real-time locational marginal price (RTLMP) for an energy generation site; generating an offer price for sale of electricity generated by the energy generation site; and posting the offer price in an offer portal. The offer price can be based at least in part on the forecasted RTLMP and one or more agreement parameters. The offer price can be configured to reduce a basis risk if the offer price clears a market price.

In any of the embodiments disclosed herein, determining the forecasted RTLMP for an energy generation site (e.g., a renewable energy site) can include determining a forecasted RTLMP for a hub of the energy generation site.

In any of the embodiments disclosed herein, the one or more agreement parameters can include a power purchase agreement (PPA) value, a production tax credit (PTC) value, or any combination thereof.

In any of the embodiments disclosed herein, the offer price can be generated further based at least in part on a floor price and a ceiling price.

In any of the embodiments disclosed herein, the offer price can be generated via a formula comprising: Offer Price=Min((Max(P_{floor}, P_{Hub FX})−PPA−PTC),Offer Limit). P_{floor} can be a floor price, P_{Hub FX} can be the forecasted RTLMP, PPA can be a power purchase agreement value, PTC can be production tax credit value, and Offer Limit can be a ceiling price.

In any of the embodiments disclosed herein, the offer price can clear a market price only if a sum of the one or more agreement parameters is greater than the basis risk.

In any of the embodiments disclosed herein, the forecasted RTLMP can be a first forecasted RTLMP, wherein the offer price is a first offer price, the method further including determining a second forecasted RTLMP, after a set time interval, for the energy generation site, the second RTLMP based, at least in part, on a change in market conditions; generating a second offer price based on the second forecasted RTLMP and the one or more agreement parameters; and posting the second offer price, after the set time interval, in the offer portal. The second offer price can be configured to reduce a basis risk if the second offer price clears a market price.

An exemplary embodiment of the present disclosure provides a method including: determining a forecasted real-time locational marginal price (RTLMP) for a hub of an energy generation site; generating an offer price based at least in part on the forecasted RTLMP and one or more agreement parameters such that the offer price is configured to clear a market price only if a basis risk is less than one or more agreement parameters; and posting the offer price to an offer portal of a grid operator.

In any of the embodiments disclosed herein, the method can further include updating the offer price, in real-time, based at least in part on a change in market conditions.

In any of the embodiments disclosed herein, a change in market conditions can cause a change in the forecasted RTLMP.

In any of the embodiments disclosed herein, the one or more agreement parameters can include a power purchase agreement (PPA) value and a production tax credit (PTC) value.

In any of the embodiments disclosed herein, the offer price can be further configured to prevent a basis risk greater than a sum of values of the one or more agreement parameters if the offer price does not clear the market price.

An exemplary embodiment of the present disclosure provides a system including one or more processors; and memory including instructions that when executed by the one or more processors, cause the one or more processors to determine a forecasted real-time locational marginal price (RTLMP) for an energy generation site; generate an offer price for sale of electricity generated by the energy generation site; and post the offer price in an offer portal. The offer price can be based at least in part on the forecasted RTLMP and one or more agreement parameters. The offer price can be configured to reduce a basis risk if the offer price clears a market price.

In any of the embodiments disclosed herein, the forecasted RTLMP for an energy generation site can be determined, at least in part, by determining a forecasted RTLMP for a hub of the energy generation site.

In any of the embodiments disclosed herein, the one or more agreement parameters can include a power purchase agreement (PPA) value, a production tax credit (PTC) value, or any combination thereof.

In any of the embodiments disclosed herein, the offer price can be generated further based at least in part on a floor price and a ceiling price.

In any of the embodiments disclosed herein, the offer price can be generated via a formula including: Offer Price=Min((Max (P_{floor}, P_{Hub FX})−PPA−PTC),Offer Limit). P_{floor} can be a floor price, P_{Hub FX} can be the forecasted RTLMP, PPA can be a power purchase agreement value, PTC can be production tax credit value, and Offer Limit can be a ceiling price.

In any of the embodiments disclosed herein, the offer price can clear a market price only if a sum of the one or more agreement parameters is greater than the basis risk.

In any of the embodiments disclosed herein, the offer price can be generated such that the offer price can clear a market price only if the basis risk is less than the one or more agreement parameters.

In any of the embodiments disclosed herein, the instructions, when executed by the one or more processors, can further cause the one or more processors to update the offer price in real-time based at least in part on an outcome of a previous offer price.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 illustrates an example system for avoiding basis risk for energy generation sites, in accordance with examples of the disclosed technology.

FIG. 2 illustrates an example computing device configured to avoid basis risk for energy generation sites, in accordance with examples of the disclosed technology.

FIG. 3 is a flow diagram illustrating an exemplary method of avoiding basis risk for energy generation sites, in accordance with examples of the disclosed technology.

FIG. 4 is another flow diagram illustrating an exemplary method of avoiding basis risk for energy generation sites, in accordance with examples of the disclosed technology.

FIG. 5. is yet another flow diagram illustrating an exemplary method of avoiding basis risk for energy generation sites, in accordance with examples of the disclosed technology.

FIG. 6 is yet another flow diagram illustrating an exemplary method of avoiding basis risk for energy generation sites, in accordance with examples of the disclosed technology.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Although various aspects of the disclosed technology are explained in detail herein, it is to be understood that other aspects of the disclosed technology are contemplated. Accordingly, it is not intended that the disclosed technology is limited in its scope to the details of construction and arrangement of components expressly set forth in the following description or illustrated in the drawings. The disclosed technology can be implemented and practiced or carried out in various ways. In particular, the presently disclosed subject matter is described in the context of being systems and methods for avoiding basis risk for energy generation sites. The present disclosure, however, is not so limited, and can be applicable in other contexts in which data is provided by a human and entered into a computing system. For example, the disclosed technology can be applicable to systems in which a human can enter data via a keyboard, a mouse, a microphone (e.g., interactive voice response (IVR)), or other devices configured to provide data from a human to a computing system. Accordingly, when the present disclosure is described in the context of systems and methods for basis avoidance for energy generation sites, it will be understood that other implementations can take the place of those referred to.

It should also be noted that, as used in the specification and the appended claims, the singular forms “a,” “an,” and “the” include plural references unless the context clearly dictates otherwise. References to a composition containing “a” constituent is intended to include other constituents in addition to the one named.

Also, in describing the disclosed technology, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, the disclosed technology can include from the one particular value and/or to the other particular value. Further, ranges described as being between a first value and a second value are inclusive of the first and second values. Likewise, ranges described as being from a first value and to a second value are inclusive of the first and second values.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

It is also to be understood that the mention of one or more method steps does not preclude the presence of additional method steps or intervening method steps between those steps expressly identified. Moreover, although the term “step” can be used herein to connote different aspects of methods employed, the term should not be interpreted as implying any particular order among or between various steps herein disclosed unless and except when the order of individual steps is explicitly required. Further, the disclosed technology does not necessarily require all steps included in the methods and processes described herein. That is, the disclosed technology includes methods that omit one or more steps expressly discussed with respect to the methods described herein.

As used herein, the term “node” can include any location that would be considered by one of ordinary skill in the art to be a point of energy trading. As non-limiting examples, nodes can include substations, busses, interconnection points, transmission points, generation points, and load points. A node can refer to any point in an electric grid where electricity can be injected, withdrawn, transferred, sold, or any combination thereof.

Likewise, as used herein, the term “node price” can include any price associated with a node of the electric grid. As non-limiting examples, a node price can include a locational marginal price of the node, a cost of generating a next unit of energy at the node, a marginal cost of the node, or similar costs of prices associated with electricity transactions at a node in the electric grid.

As used herein, the term “hub” can include any point within the electric grid that would be considered by one of ordinary skill in the art to be a central location for transmission and distribution of electricity. As non-limiting examples, a hub can include a point of interconnection for any number of substations, busses, transmission lines, or any other electrical component in the electric grid. A hub may define a region including one or more nodes, such that a hub can be associated with one or more nodes located within the geographic region defined by the hub. A hub can be a reference point for pricing and trading electricity, or specifically renewable energy.

Likewise, as used herein, the term “hub price” can include any price associated with a hub of the electric grid. As non-limiting examples, a hub price can include a locational marginal price of the hub, a cost of generating a next unit of energy at the hub, a marginal cost of the hub, or similar costs of prices associated with electricity transactions at a hub in the electric grid. The hub price, as a non-limiting example, can include a weighted average price of one or more nodes located within a region defined by the hub. Further, the hub price can be determined by a grid operator based on node prices located within a geographic area of the hub.

As used herein, the term “grid operator” can include any entity associated with the coordination, control, and monitoring of the electric grid. As non-limiting examples, a grid operator can include an independent system operator (ISO), a regional transmission organization (RTO), a load-serving entity, or vertically integrated utility. The grid operator can include any entity which receives offer bids, offers, bids, or offer prices for the sale of electricity from another party and accepts one or more of the offer bids, offers, bids, or offer prices based on supply and demand of electricity.

As used herein, the term “locational marginal price” or “LMP” can be defined as understood in the art. Specifically, the locational marginal price can be defined as a cost of a next increment of electricity for a location. The locational marginal price can be a price of the next unit of energy in the sale of electricity. As non-limiting examples, the locational marginal price can be determined for a node, a hub, a collection of nodes, a collection of hubs, and similar contexts understood in the art. The locational marginal price for a node or hub may be determined by a grid operator. In some embodiments, the locational marginal price for a node or hub can be forecasted by parties to a renewable energy transaction to predict supply and demand trends of the energy trade.

As used herein, the term “power purchase agreement” or “PPA” can include any agreement for a sale of electricity in the energy trade. Specifically, as a non-limiting example, a PPA can include an agreement between a power producer, or seller, and a power purchaser, or buyer, to define terms for a sale and purchase of electricity. A power purchase agreement can include clauses for a term, electricity price, electricity, quantity, delivery point, risk allocation, or any other contractual clauses for similar agreements known in the art. Some power purchase agreements include a fixed price for electricity throughout the term, and some power purchase agreements include a variable price. A variable price in a power purchase agreement, in some non-limiting examples, can be based at least in part on a hub price, or LMP at a hub.

As used herein, the term “production tax credit” or “PTC” can include any incentive provided to a party in a renewable energy transaction to promote generation and development of renewable energy projects. As a non-limiting example, a PTC can include a tax credit paid to a renewable energy generator, project owner, or renewable energy producer. An amount of the tax credit associated with the PTC can vary based at least in part on an energy project type, an energy production amount, inflation, and similar parameters for adjusting tax credits of similar contexts as known in the art.

As used herein, the term “basis risk” can be defined as is understood in the art. Specifically, as a non-limiting example, basis risk can include a difference between a node price and a hub price. Furthermore, basis risk can include a difference between LMP at a node and LMP at a hub. As can be appreciated, basis risk can be associated with a cost owed by one party of a virtual or physical energy transaction to another party of a virtual or physical energy transaction based on a difference in locational marginal pricing between a node and a corresponding hub or any two differing market settlement locations spatially. Additionally, basis risk can refer to a difference in price between what one party receives from sale of electricity to the grid at a node price and what another party receives as a result of terms in a PPA.

Reference will now be made in detail to example embodiments of the disclosed technology that are illustrated in the accompanying drawings and disclosed herein. Wherever convenient, the same reference numbers will be used throughout the drawings to refer to the same or like parts.

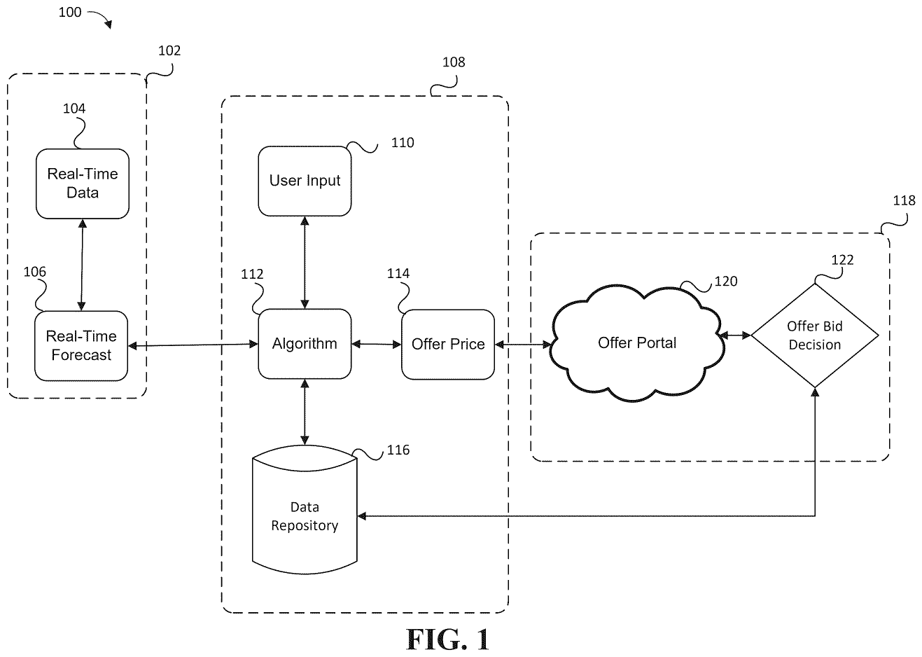

FIG. 1 illustrates an example system 100 for avoiding basis risk for an energy generation site. One of skill in the art will appreciate that the various features of the system 100 described herein can be incorporated into a single computing device or be divided into distinct parts across a network of computing devices. Thus, although the various features of the system 100 may be described as separate and distinct features or components, the described technology is not so limited.

Systems and methods for avoiding basis risk for an energy generation site are discussed herein. As can be appreciated, energy generation sites can include fossil fuel power plants, nuclear power plants, and renewable energy sites. Further, renewable energy sites can include wind plants, solar plants, hydroelectric plants, geothermal power plants, and any other sources of renewable energy generation known in the art. Any system and method for avoiding basis risk for an energy generation site can include any examples of energy generation sites discussed herein. In particular, any examples of systems and methods for avoiding basis risk for energy generation sites can include renewable energy sites. As can be appreciated, renewable energy sites can include additional parameters which can be considered when avoiding basis risk as compared to other types of energy generation.

The system 100 can include a forecasting program 102 that can be configured to produce forecasted price data for the sale of electricity in real-time. The forecasting program 102 can be configured to receive real-time data 104 related to an energy generation site. In some embodiments, the real-time data 104 can include price data for the energy generation site. The real-time data 104 can include price data for a hub associated with the energy generation site. In some embodiments, the real-time data 104 can include a node price for an energy generation site and a corresponding hub price for the energy generation site. The real-time data 104 can include LMP data for one or more of a node of the energy generation site, a hub of the energy generation site, and nearby nodes of the energy generation site. The real-time data 104, in some embodiments, can be received by the forecasting program 102 via a grid operator. The grid operator, in some embodiments, can be an independent system operator (ISO) or a regional transmission organization (RTO). That is, the ISO or RTO may produce the real-time data 104 and allow the forecasting program 102 access to the real-time data 104. In some embodiments, the real-time data 104 can be determined via the system 100.

The forecasting program 102 can be configured to generate a real-time forecast 106. The real-time forecast 106 can include a forecasted real-time locational marginal price (RTLMP). The forecasted RTLMP can include a forecasted locational marginal price for a node of an energy generation site. In some embodiments, the forecasted RTLMP can include a forecasted locational marginal price for a hub of an energy generation site. That is, the forecasted RTLMP can be a forecasted hub price for an energy generation site. In this way, the real-time forecast 106 can be characterized by predicting a future LMP of one of a node or hub of an energy generation site. By forecasting the LMP at the node or the hub for the energy generation site, examples of the present disclosure can attempt to mitigate basis risk via augmenting an offer price 114 based at least in part on the real-time forecast 106, as will be discussed in greater detail herein.

The system 100 can include an offer application 108. The offer application 108 can be configured to receive a user input 110. As can be appreciated, the system 100 can further include a user interface that can be configured to receive inputs from a user and display data for the user to view. As a non-limiting example, the user interface can be a screen of a computing device that is configured to display data for the user. The user interface can receive an input from a user, for example, by a touch screen, a mouse, a keyboard, or other methods of inputting data to a user interface as is known in the art. In some embodiments, the user input 110 can include data related to a power purchase agreement (PPA) for an energy generation site. As can be appreciated, the PPA can be related to a renewable energy transaction, such that the energy generation site can be a renewable energy site. That is, the user input 110 can include a PPA value, which, in some embodiments, can be a dollar amount related to a power purchase agreement for the energy generation site. In this way, the offer price 114 can be based at least on the PPA value and may additionally include an offer volume or other required components of an offer as constituted by that grid operator. The user input 110 can include data related to a production tax credit (PTC) for an energy generation site. As can be appreciated, a PTC can be for a renewable energy site, such that as a part of a PPA for a renewable energy transaction, one party can receive the PTC in exchange for renewable generated energy. That is, the user input 110 can include a PTC value, which, in some embodiments, can be a dollar amount related to a power purchase agreement for the energy generation site. In this way, the offer price 114 can be based at least in part on the PTC value. The user input 110 can further include a ceiling price, or offer limit, and a floor price. As can be appreciated, the user may select a ceiling price and a floor price based at least in part on characteristics of the energy generation site, a PPA, relevant parties to a PPA, market trends, historical data, previous offer prices, and similar data which may influence the selection of bounds for the offer price 114 and any additional offer parameters. The user input 110 can further include prices for environmental attributes of a site, date and time ranges for the application of offers, site telemetry including outage and operational capabilities and any other contractual value from generation at the site.

The offer application 108 can include an algorithm 112 configured to generate the offer price 114 for the sale of electricity at an energy generation site. The algorithm 112 can be implemented by any embodiments of computing devices discussed herein. The algorithm 112 can be configured to receive the user input 110. The algorithm 112 can be in communication with the forecasting program 102, such that the algorithm 112 can be configured to receive the real-time forecast 106 from the forecasting program 102. That is, the algorithm 112 can generate the offer price 114 based at least in part on a node price for an energy generation site, a hub price for an energy generation site, a forecasted RTLMP, an LMP of the node price, an LMP of the hub price, or any combination thereof.

Further, the algorithm 112 can be configured to determine a relevant PPA for an energy generation site. That is, the algorithm 112 can be configured to determine the PPA value. The algorithm 112 can be configured to determine the PPA value based at least in part on the real-time data 104, historical data, or any combination thereof, as will be discussed in greater detail herein. Similarly, the algorithm 112 can be configured to determine a relevant PTC for an energy generation site. In this way, the algorithm 112 can be configured to determine the PTC value. The algorithm 112 can be configured to determine the PTC value based at least in part on the relevant PPA, the real-time data 104, historical data, or any combination thereof. The algorithm 112 can be configured to determine the floor price and the ceiling price. Specifically, the algorithm 112 can be configured to determine the floor price and the ceiling price based at least in part on the real-time data 104, historical data, the PPA, the PPA value, the PTC, the PTC value, relevant parties to the PTC, an ISO of the energy generation site, an RTO of the energy generation site, or any combination thereof.

The algorithm 112 can be in communication with a data repository 116. That is, the offer application 108 can further include the data repository 116. The data repository 116 can be configured to store data which may be used by the algorithm 112 to generate the offer price 114. In some embodiments, the data repository 116 can include historical data. The historical data can include previous offer prices, previous offer decisions, whether a previous offer cleared the market, historical node price data, historical hub price data, historical LMP data for nodes and hubs, historical RTLMP values and corresponding prices, or any combination thereof. The data repository 116 may include electric grid data, such as grid operator regions, ISO/RTO regions, ISO/RTO locations, substation locations, substation capacities, node locations, hubs associated with each node, electrical components associated with each node, and similar data related to a general layout of the electric grid. In some embodiments, the data repository 116 can be associated with a particular grid operator, such that the algorithm 112 can be in connection with multiple of the data repository 116. The multiple data repositories may each be associated with a different grid operator. In some embodiments, the multiple data repositories may each be associated with a different data type or category. Nonetheless, the multiple of the data repository 116, as can be appreciated, may effectively act as a single data repository 116 including any embodiments of the data repository 116 discussed herein.

The offer application 108 can be configured to output the offer price 114. That is, the algorithm 112 of the offer application 108 can be configured to generate the offer price 114. The offer price 114 can be for the sale of electricity generated by an energy generation site. As discussed herein, the offer price 114 can be submitted to a grid operator by a renewable energy generator or project owner. The offer price 114 can be generated based at least in part on the real-time forecast 106. Specifically, the offer price 114 can be generated based at least in part on the forecasted RTLMP, including any embodiments of the forecasted RTLMP discussed herein. The offer price 114, in some embodiments, can be a dollar amount associated with an amount of energy to be offered as a bid to an ISO or RTO. In this way, the offer price 114 can be received and considered by an ISO or RTO.

The offer price 114 can be based at least in part on one or more agreement parameters. The one or more agreement parameters, in some embodiments, can include dollar amount values of cashflows between parties in an energy transaction. For example, the one or more agreement parameters can include the PPA value. In this way, the offer price 114 can be generated such that a dollar amount value representative of a transaction between parties in accordance with a PPA can be considered. Generating the offer price 114 based at least in part on the PPA value can allow the offer price 114 to be configured to reduce the basis risk incurred on any party to an energy transaction. Additionally, the one or more agreement parameters can include the PTC value. In this way, generating the offer price 114 based at least in part on the PTC value can allow the offer price 114 to be configured to reduce the basis risk incurred on any part to an energy transaction.

The offer price 114 can be configured to be submitted to a grid operator program 118. The grid operator program 118 can include an offer portal 120. The offer portal 120 can be an internet-based application, website, webpage, or similar applications. The offer portal 120 can be configured to receive the offer price 114. The offer portal 120 can be configured to receive an offer bid including the offer price 114. Further, the offer portal 120 can be configured to receive a plurality of offer bids from energy generators or project owners. The algorithm 112, in some embodiments, can be configured to submit the offer price 114 to the offer portal 120. Further, the algorithm 112 can be configured to submit, or post, the offer price 114 as part of an offer bid to the offer portal 120. In this way, the offer price 114 can be combined with an offer energy quantity to form the offer bid. That is, in some embodiments, the offer bid can include the offer price and an offer volume. The offer volume, as can be appreciated, can include the offer energy quantity, or any similar metric to define a volume of energy to be bought and sold. The offer volume can be defined in power, such as MW, or energy, such as MWh. Similarly, the offer bid can be generated by generating the offer price and the offer volume. Additionally, in some embodiments, the offer bid can further include physical parameters. The physical parameters can include any combination of a high sustainability limit, a site status, ramp rates, timestamps, or any other metadata of similar contexts. The offer bid can be configured to be processed by a grid operator, such as an ISO or an RTO. The offer portal 120, in some embodiments, can be configured to receive a plurality of offer bids for a given time increment within a time interval. For example, the offer portal 120 can be configured to group received offer bids by the time interval during a day which the received offer bids were posted. In this way, the offer portal 120 can group, or categorize, offer bids of the plurality of offer bids based on a time posted. The offer portal 120 can be any mechanism known in the art for a grid operator to receive an offer for sale of electricity. That is, the offer portal 120 can include any interface known in the art used by a renewable energy generator, project owner, or the like to post offer bids or offer prices to a grid operator for a particular time interval.

The grid operator program 118 can be configured to execute an offer bid decision 122. The offer bid decision 122, as understood by those skilled in the art, can include a process executed by a grid operator where the grid operator accepts offer bids of the plurality of offer bids.

In some embodiments, the offer bid decision 122 can be a uniform market clearing decision, as understood in the art. For example, the uniform market clearing decision can include selecting a marginal market clearing price of the plurality of offer bids as the locational marginal price. The uniform market clearing decision can accept offer bids having a lower offer price than the marginal market clearing price to fit a location-specific demand. As understood in the art, the offer price 114 can clear a market price when the offer price 114 is selected as being lower than the marginal market clearing price in a uniform market clearing decision. The uniform market clearing decision can include curtailing energy output for energy generators associated with offer bids with a higher price than the marginal clearing price. The offer bid decision 122 for the offer bid including the offer price 114 can be recorded and stored in the data repository 116 as part of the historical data.

The offer bid decision 122 can be executed by the grid operator at regular time intervals. For example, the offer bid decision 122 can be part of a plurality of offer bid decisions executed within a given time interval throughout a day. Accordingly, the offer bid decision 122 can be executed every 5 minutes, every 15 minutes, every 30 minutes, or any time interval of offer bid decisions known in the art. In this way, the algorithm 112 can be configured to update and post the offer bid including the offer price 114 to the offer portal 120 at regular time intervals, such that the offer price 114 can be considered for multiple of the offer bid decision 122.

The offer price 114, in some embodiments, can be generated such that the offer price 114 can be configured to reduce a basis risk if the offer price 114 clears a market price. That is, the offer price 114 can be configured to reduce the basis risk if the offer price 114 is less than the marginal clearing price. Further, the offer price 114 can be configured to reduce the basis risk if the offer price 114 is less than the LMP at a respective node for the energy generation site. In some embodiments, the offer price 114 can be configured to clear the market price only if the basis risk is less than the one or more agreement parameters. That is, the offer price 114 can be configured to prevent or clear a market price only if a sum of the one or more agreement parameters is greater than the basis risk. In this way, generating the offer price 114 based at least in part on the one or more agreement parameters can allow the offer price 114 to be configured to prevent or reduce the basis risk. Specifically, the offer price 114 can be configured to prevent basis risk incurred on any part of a renewable energy transaction if the offer price 114 clears the market price. In some embodiments, the offer price 114 can be configured to prevent a basis risk greater than a sum of values of the one or more agreement parameters if the offer price 114 does not clear the market price. That is, if the offer price 114 does not clear the market price, the offer price 114 can be configured to prevent the basis risk from being greater than the sum of the one or more agreement parameters. The configurations of the offer price 114 discussed herein can be generally directed towards mitigating basis risk whether the offer price 114 clears the market price or not. If the offer price 114 clears the market price, some embodiments of the offer price 114 can be configured to have a near zero basis risk. Alternatively, if the offer price 114 does not clear the market price, some embodiments of the offer price 114 can be configured to prevent the basis risk inherent to not clearing the market price from being greater than any forgone costs, such as the one or more agreement parameters.

The offer price 114, in some embodiments, can be generated via a formula. The formula, in an exemplary embodiment, can be: Offer Price=Min((Max (P_{floor}, P_{Hub FX})−PPA−PTC),Offer Limit), such that P_{floor} can be the floor price, P_{Hub FX} can be the real-time forecast 106, PPA can be the PPA value, PTC can be the PTC value, and Offer Limit can be the ceiling price. In another exemplary embodiment, P_{Hub FX} can be the forecasted RTLMP, including any embodiments of the forecasted RTLMP discussed herein. The formula, as can be appreciated, can be configured to incorporate the one or more agreement parameters into the calculation of the offer price 114. In this way, if the offer price 114 is accepted by a grid operator, further monetary transactions including parties to the renewable energy transaction can be accounted for in the offer price 114, thus allowing the offer price 114 to be configured to prevent basis risk.

In an example embodiment, the forecasting program 102 can be configured to generate the real-time forecast 106 at a regular interval. Continuing the example embodiment, the algorithm 112 can be configured to receive the real-time forecast 106 at the regular interval. In the continued example embodiment, the offer price 114 can be generated at the regular time interval based at least in part on the real-time forecast 106. In the continued example embodiment, the offer application 108 can be configured to post an offer bid including the offer price 114 to the offer portal 120 at the regular time interval. In the continued example embodiment, the grid operator application 118 can execute the offer bid decision 122 at the regular time interval, such that the offer price 114, or any offer price generated by the offer application 108 at a different time interval of the regular time interval, can be considered in the offer bid decision 122 or any offer bid decision occurring at a different time interval of the regular time interval. In this way, as can be appreciated, the offer application 108 can be configured to generate offer prices at time intervals so as to effectively update the offer price at predetermined time intervals such that updated offer bids including the updated offer prices can be considered at offer bid decisions occurring at a regular time interval.

The system 100 can further include a settlement system configured to model revenues for the energy generation site. In some embodiments, the settlement system can be configured to model revenues based at least in part on the offer price 114. That is, the settlement system can be configured to determine a potential revenue for an energy generation site based at least in part on the offer price, the offer volume, historical data, or any combination thereof. In this way, the settlement system can be used to predict a viability of an energy generation site, or at least influence the determination of future offer prices or offer bids.

The system 100 can include an application that can be in communication with the user interface and a machine learning model. As non-limiting examples, the application can be an extension of a browser, a software program, a program or feature of a kernel of the system, or any computer application that can perform the functions described herein.

As will be appreciated, as the machine learning model is trained and becomes more accurate over time, the amount of frequency of user inputs of the user input 110 can be reduced. In other words, as the machine learning model becomes more accurate over time, the need for human oversight of the machine learning model can decrease and the machine learning model can operate largely unsupervised.

The machine learning model can be or include a neural network, a recurrent neural network, a Long Short-Term Memory (LSTM) network, a bi-direction LSTM network, a Conditional Random Fields (CRF) network, an LSTM-CRF network, a Bi-LSTM-CRF network, or other suitable machine learning models. In some embodiments, the machine learning model can employ a gradient boosting model, a light gradient boosting model, or similar models known in the art.

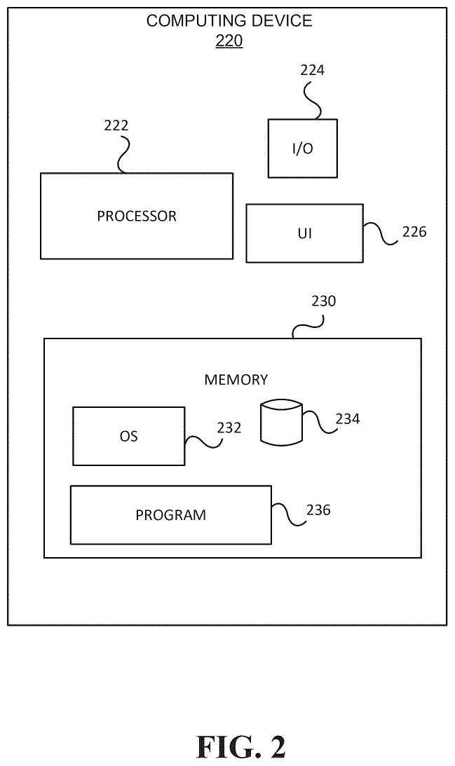

FIG. 2 illustrates an example computing device configured to avoid basis risk for energy generation sites, in accordance with examples of the disclosed technology. As will be appreciated by one of skill in the art, the computing device 220 can be configured to include all or some of the features described in relation to the system 100. As shown, the computing device 220 may include a processor 222, an input/output (“I/O”) device 224, a memory 230 containing an operating system (“OS”) 232 and a program 236. In certain example implementations, the computing device 220 may be a single server or may be configured as a distributed computer system including multiple servers or computers that interoperate to perform one or more of the processes and functionalities associated with the disclosed embodiments. In some embodiments, computing device 220 may be one or more servers from a serverless or scaling server system. In some embodiments, the computing device 220 may further include a peripheral interface, a transceiver, a mobile network interface in communication with the processor 222, a bus configured to facilitate communication between the various components of the computing device 220, and a power source configured to power one or more components of the computing device 220.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 222 to communicate with other devices via wired or wireless networks, whether local or wide area, private or public, as known in the art. A power source may be configured to provide an appropriate alternating current (AC) or direct current (DC) to power components.

The processor 222 may include one or more of a microprocessor, microcontroller, digital signal processor, co-processor or the like or combinations thereof capable of executing stored instructions and operating upon stored data. The memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 230.

The processor 222 may be one or more known processing devices, such as, but not limited to, a microprocessor from the Pentium™ family manufactured by Intel™ or the Turion™ family manufactured by AMD™. The processor 222 may constitute a single core or multiple core processor that executes parallel processes simultaneously. For example, the processor 222 may be a single core processor that is configured with virtual processing technologies. In certain embodiments, the processor 222 may use logical processors to simultaneously execute and control multiple processes. The processor 222 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the computing device 220 may include one or more storage devices configured to store information used by the processor 222 (or other components) to perform certain functions related to the disclosed embodiments. In one example, the computing device 220 may include the memory 230 that includes instructions to enable the processor 222 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, the computing device 220 may include a memory 230 that includes instructions that, when executed by the processor 222, perform one or more processes consistent with the functionalities disclosed herein. Methods, systems, and articles of manufacture consistent with disclosed embodiments are not limited to separate programs or computers configured to perform dedicated tasks. For example, the computing device 220 may include the memory 230 that may include one or more programs 236 to perform one or more functions of the disclosed embodiments.

The processor 222 may execute one or more programs located remotely from the computing device 220. For example, the computing device 220 may access one or more remote programs that, when executed, perform functions related to disclosed embodiments.

The memory 230 may include one or more memory devices that store data and instructions used to perform one or more features of the disclosed embodiments. The memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 230 may include software components that, when executed by the processor 222, perform one or more processes consistent with the disclosed embodiments. In some examples, the memory 230 may include a database 234 configured to store various data described herein. For example, the database 234 can be the data repository 116.

The computing device 220 may also be communicatively connected to one or more memory devices (e.g., databases) locally or through a network. The remote memory devices may be configured to store information and may be accessed and/or managed by the computing device 220. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The computing device 220 may also include one or more I/O devices 224 that may comprise one or more user interfaces 226 (e.g., user interface) for receiving signals or input from devices and providing signals or output to one or more devices that allow data to be received and/or transmitted by the computing device 220. For example, the computing device 220 may include interface components, which may provide interfaces to one or more input devices, such as one or more keyboards, mouse devices, touch screens, track pads, trackballs, scroll wheels, digital cameras, microphones, sensors, and the like, that enable the computing device 220 to receive data from a user.

In example embodiments of the disclosed technology, the computing device 220 may include any number of hardware and/or software applications that are executed to facilitate any of the operations. The one or more I/O devices 224 may be utilized to receive or collect data and/or user instructions from a wide variety of input devices. Received data may be processed by one or more computer processors as desired in various implementations of the disclosed technology and/or stored in one or more memory devices.

While the computing device 220 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the computing device 220 may include a greater or lesser number of components than those illustrated.

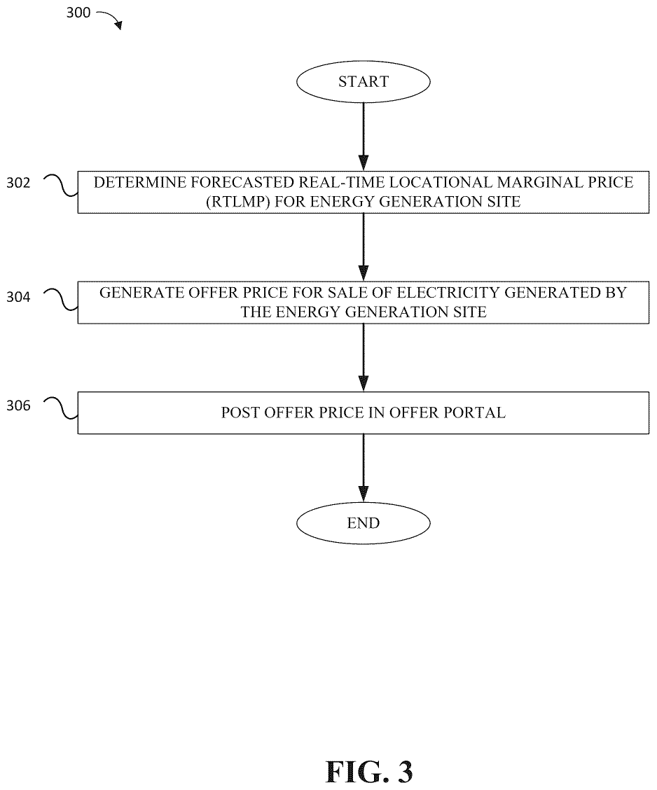

FIG. 3 is a flow diagram illustrating a method 300 for generating variable offer prices for sale of electricity from energy generation sites. The method 300 can include determining 302 a forecasted RTLMP for an energy generation site. In some embodiments, the forecasted RTLMP can be associated with a real-time node price. In some embodiments, the forecasted RTLMP can be associated with a real-time hub price. The forecasted RTLMP can be any embodiments of the forecasted RTLMP as discussed herein. The forecasted RTLMP can be determined by a grid operator. That is, in some embodiments, determining 302 the forecasted RTLMP can include receiving an RTLMP from a grid operator. The forecasted RTLMP, in some embodiments, can be determined via a machine learning model. The machine learning model, in some embodiments, can determine the forecasted RTLMP via a gradient boosting model. As discussed herein, the forecasted RTLMP can be based at least in part on real-time node data, real-time hub data, historical node data, historical hub data, transmission congestion, an electricity supply at the node, an electricity demand at the node, an electricity supply at the hub, an electricity demand at the hub, renewable energy requirements of power producers, renewable energy requirements of power purchasers, or any combination thereof. The forecasted RTLMP can be determined via the forecasting program 102 discussed herein.

The method 300 can include generating 304 an offer price for sale of electricity generated by the energy generation site. The offer price can include any embodiments of the offer price 114 discussed herein. For example, the offer price can be based at least in part on the forecasted RTLMP. In some embodiments, the offer price can be based at least in part on one or more agreement parameters, as discussed in greater detail herein. The one or more agreement parameters can include the PPA value, the PTC value, or any combination thereof. The offer price can be further based on a ceiling price and a floor price, as discussed herein. The offer price can be generated via the offer application 108. That is, the offer price can be generated via the algorithm 112. The offer price can be configured to reduce the basis risk if the offer price clears a market price. In some embodiments, the offer price can clear a market price only if a sum of the one or more agreement parameters is greater than the basis risk. That is, the offer price can be configured to clear a market price only if a basis risk is less than the one or more agreement parameters. Additionally, the offer price can be further configured to prevent basis risk greater than a sum of values of the one or more agreement parameters if the offer price does not clear the market price. In this way, in some embodiments, the offer price can be configured to prevent basis risk if the offer price clears, and the offer price can be configured to prevent basis risk greater than a PPA cost and a PTC cost, such that the PPA cost and the PTC cost are forgone costs. Specifically, the offer price can be generated in such a way that an upper bound for the basis risk can be a sum of the PPA value and the PTC value. The offer price, and any offer price discussed for any of the methods herein, can be a part of an offer bid, as discussed herein. The offer bid can include any embodiments of offer bids discussed herein. For example, the offer bid can include the offer price and an offer volume. That is, the offer price can be generated based at least in part on an offer volume. In some embodiments, the offer volume can be generated based at least in part on the offer price. In some embodiments, the offer volume and the offer price can be generated separately based at least in part on the forecasted RTLMP, and later combined to be the offer bid.

The method 300 can include posting 306 the offer price in an offer portal. The offer portal can be any embodiments of the offer portal 120 discussed herein. That is, the posting 306 the offer price to the offer portal can include submitting an offer bid including the offer price to the grid operator program 118. The offer price can be posted to the offer portal automatically a system such as the offer program 108. In some embodiments, the offer price can be manually reviewed and submitted by a user.

The method 300, and any of the methods discussed herein, can include any embodiments of the settlement system discussed herein. That is, the method 300, and any of the methods discussed herein, can further include receiving the offer price at a settlement system. The method 300, and any of the methods discussed herein, can further include modelling revenues for the energy generation site based at least in part on the offer price. As can be appreciated, modelling revenues for the energy generation site can include generating forecasted revenue for the energy generation site based at least in part on the forecasted RTLMP. Further, the forecasted revenue for the energy generation site can be generated based at least in part on the offer price and an offer volume. Additionally, the forecasted revenue can be generated based at least in part on historical data, including one or more previous offer prices, one or more previous offer bids, one or more previous offer volumes, or any combination thereof.

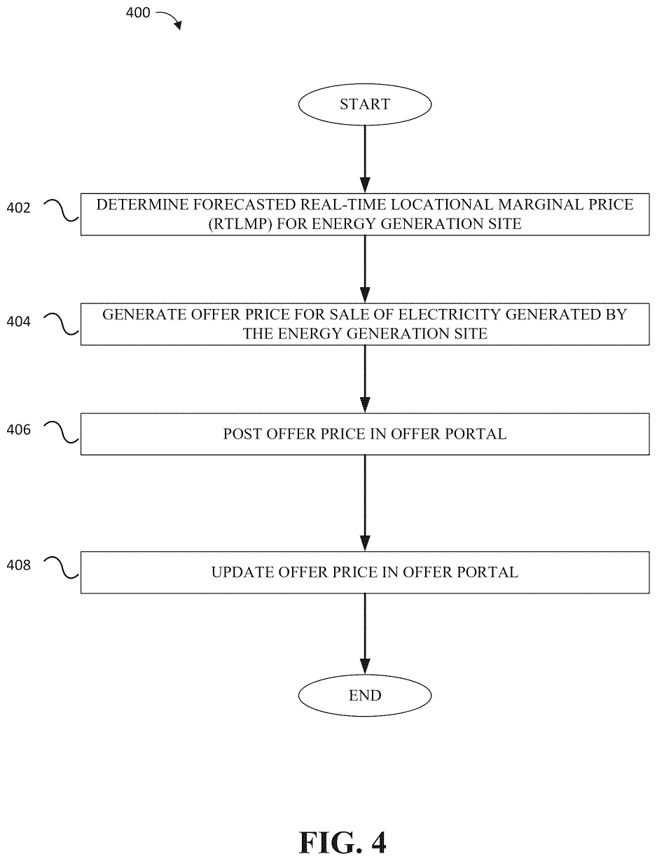

FIG. 4 is another flow diagram illustrating an exemplary method 400 for generating variable offer prices for sale of electricity at energy generation sites. As before, the method 400 can include determining 402 a forecasted RTLMP for an energy generation site; As before, the method 400 can further include generating 404 an offer price for sale of electricity generated by the energy generation site. As before, the method 400 can further include posting 406 the offer price in an offer portal.

Additionally, the method 400 can include updating 408 the offer price in the offer portal. Updating 408 the offer price in the offer portal can include updating the offer price, in real-time, in the offer portal. The offer price can be updated based at least in part on a change in market conditions. In some embodiments, a change in market conditions can cause a change in the forecasted RTLMP. That is, updating the offer price in the offer portal based at least in part on a change in market conditions can include updating the offer price in the offer portal based at least in part on a change in the forecasted RTLMP. As discussed herein, the forecasted RTLMP can be received at a regular time interval. That is, a change in the forecasted RTLMP can occur at the regular time interval. In this way, the offer price, after being posted in the offer portal, can be updated, after which an updated offer price can be posted in the offer portal. As can be appreciated, the updated offer price can be considered under a different time interval group than the initial offer price.

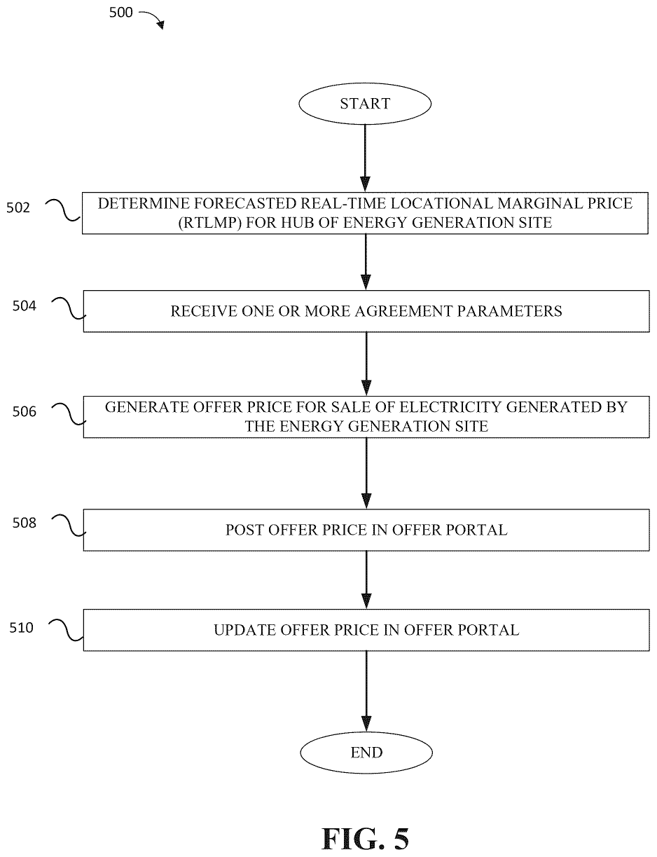

FIG. 5. is yet another flow diagram illustrating an exemplary method 500 for avoiding basis risk for energy generation sites. The method 500 can include determining 502 a forecasted RTLMP for a hub of an energy generation site. As can be appreciated, determining 502 the forecasted RTLMP for the hub of an energy generation site can include receiving a real-time LMP from a grid operator. In some embodiments, as discussed herein, the forecasted RTLMP for the hub of the energy generation site can be determined via the forecasting program 102. The forecasted RTLMP for the hub of the energy generation site can be determined via a machine learning model. For example, the forecasted RTLMP for the hub can be determined based at least in part on a light-gradient boosting model.

The method 500 can include receiving 504 one or more agreement parameters. The one or more agreement parameters can be based at least in part on agreements between parties of a renewable energy transaction, as discussed herein. For example, the one or more agreement parameters can include the PPA value, the PTC value, a ceiling price, a floor price, or any combination thereof. As before, the method 500 can include generating 506 an offer price for sale of electricity generated by the energy generation site. The offer price can be generated based at least in part on the forecasted RTLMP of the hub and the one or more agreement parameters. In some embodiments, the offer price can be generated based at least in part on the PPA value, the PTC value, a ceiling price, a floor price, or any combination thereof. The ceiling price and the floor price can be determined based at least in part on the power purchase agreement for the energy generation site, historical data, previous offer prices, previous offer bid decision data, or any combination thereof. In some embodiments, as discussed herein, the offer price can be generated using an offer price formula. The offer price formula, in an exemplary embodiment can be: Offer Price=Min((Max (P_{floor}, P_{Hub FX})−PPA−PTC),Offer Limit), such that P_{floor} can be the floor price, P_{Hub FX} can be the forecasted RTLMP, PPA can be the PPA value, PTC can be the PTC value, and Offer Limit can be the ceiling price. As before, the method 500 can include posting 508 the offer price in an offer portal. As before, the method 500 can include updating 510 the offer price in the offer portal.

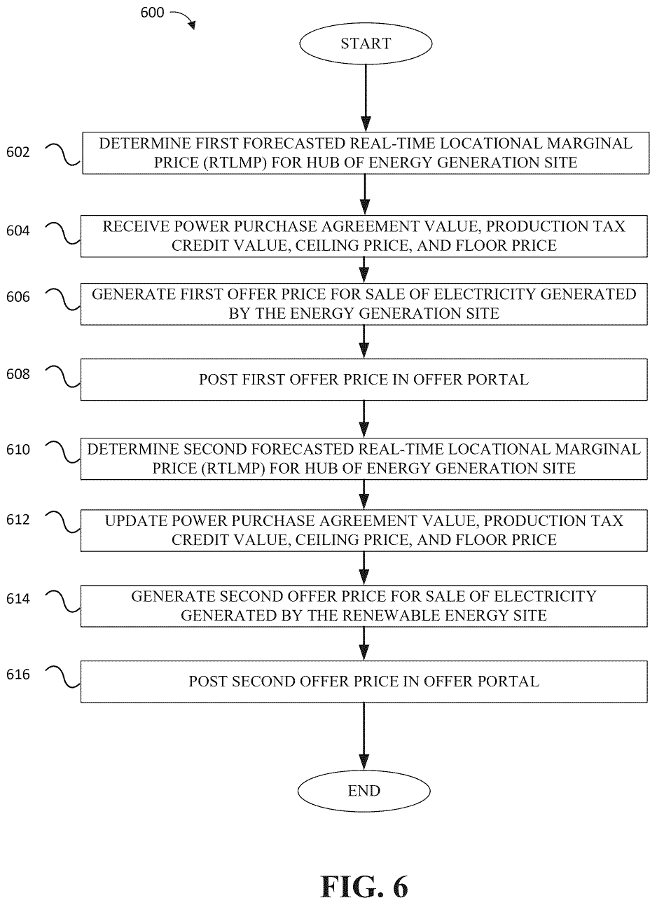

FIG. 6 is yet another flow diagram illustrating an exemplary method 600 for avoiding basis risk for energy generation sites. The method 600 can include determining 602 a first forecasted RTLMP for a hub of an energy generation site. As can be appreciated, the first forecasted RTLMP can include any embodiments of the forecasted RTLMP discussed herein. The method 600 can include receiving 604 a PPA value, a PTC value, a ceiling price, and a floor price. The PPA value, the PTC value, the ceiling price, the floor price, or any combination thereof can be received via a user input, including any embodiments of the user input 110 discussed herein. In some embodiments, the PPA value, the PTC value, the ceiling price, the floor price, or any combination thereof can be determined via an algorithm, such as the algorithm 112 discussed herein.

The method 600 can include generating 606 a first offer price for sale of electricity generated by the energy generation site. The first offer price can include any embodiments of the offer price 114 discussed herein. The first offer price can be generated based at least in part on the forecasted RTLMP, the PPA value, the PTC value, the ceiling price, the floor price, or any combination thereof. The first offer price can be generated via any embodiments of methods for generating the offer price 114 or any offer prices discussed herein. The first offer price can be configured to reduce a basis risk if the first offer price clears a market price. Further, the first offer price can be configured to clear a market price only if a sum of the PPA value and the PTC value is greater than the basis risk. The method 600 can include posting 608 the first offer price in an offer portal. Posting 608 the first offer price in the offer portal can include posting a first offer bid including the first offer price in the offer portal. In some embodiments, the first offer price can clear a market price only if a sum of the PPA value and the PTC value is greater than the basis risk.

The method 600 can include determining 610 a second forecasted RTLMP for a hub of the energy generation site. The second forecasted RTLMP can include any embodiments of the first forecasted RTLMP or the forecasted RTLMP discussed herein. The second forecasted RTLMP, in some embodiments, can be determined after a set time interval. The second forecasted RTLMP can be determined based at least in part on a change in market conditions. The method 600 can include updating 612 the PPA value, PTC value, ceiling price, and floor price. As can be appreciated, updating 612 the PPA value, PTC value, ceiling price, and floor price can include altering the PPA value, the PTC value, the ceiling price, the floor price, or any combination thereof. That is, updating 612 can include comparing a current PPA value, a current PTC value, a current ceiling price, and a current floor price to historical data; and determining whether an update is necessary. In some embodiments, the PPA value, the PTC value, the ceiling price, and the floor price can be updated based at least in part on a previous offer decision. The method 600 can include generating 614 a second offer price for sale of electricity generated by the energy generation site. Generating 614 the second offer price can include any embodiments of generating the first offer price, generating offer prices, or generating offer bids as discussed herein. Specifically, the second offer price can be generated based at least in part on the one or more agreement parameters. In some embodiments, generating 614 the second offer price can include generating a second offer bid including the second offer price. The method 600 can include posting 616 the second offer price in the offer portal. As can be appreciated, posting 616 the second offer price in the offer portal can include posting the second offer bid including the second offer price to the offer portal. The second offer price, in some embodiments, can be posted in the offer portal after the set time interval.

The disclosed technology can be further understood according to the following clauses:

Clause 1: A method for generating variable offer prices for sale of electricity at energy generation sites comprising: determining a forecasted real-time locational marginal price (RTLMP) for an energy generation site; generating an offer price for sale of electricity generated by the energy generation site, the offer price based at least in part on the forecasted RTLMP and one or more agreement parameters, wherein the offer price is configured to reduce a basis risk if the offer price clears a market price; and posting the offer price in an offer portal.

Clause 2: The method of Clause 1, wherein determining the forecasted RTLMP for an energy generation site comprises determining a forecasted RTLMP for a hub of the energy generation site.

Clause 3: The method of Clause 1, wherein the one or more agreement parameters comprise a power purchase agreement (PPA) value, a production tax credit (PTC) value, or any combination thereof.

Clause 4: The method of Clause 1, wherein the offer price is generated further based at least in part on a floor price and a ceiling price.

Clause 5: The method of Clause 1, wherein the offer price is generated via a formula comprising: Offer Price=Min((Max (P_{floor}, P_{Hub FX})−PPA−PTC),Offer Limit) wherein P_{floor} is a floor price, P_{Hub FX} is the forecasted RTLMP, PPA is a power purchase agreement value, PTC is production tax credit value, and Offer Limit is a ceiling price.

Clause 6: The method of Clause 1, wherein the offer price clears a market price only if a sum of the one or more agreement parameters is greater than the basis risk.

Clause 7: The method of Clause 1, wherein the forecasted RTLMP is a first forecasted RTLMP, wherein the offer price is a first offer price, the method further comprising: determining a second forecasted RTLMP, after a set time interval, for the energy generation site, the second RTLMP based, at least in part, on a change in market conditions; generating a second offer price based on the second forecasted RTLMP and the one or more agreement parameters, such that the second offer price is configured to reduce a basis risk if the second offer price clears a market price; and posting the second offer price, after the set time interval, in the offer portal.

Clause 8: A method comprising: determining a forecasted real-time locational marginal price (RTLMP) for a hub of an energy generation site; generating an offer price based at least in part on the forecasted RTLMP and one or more agreement parameters such that the offer price is configured to clear a market price only if a basis risk is less than one or more agreement parameters; and posting the offer price to an offer portal of a grid operator.

Clause 9: The method of Clause 8, further comprising updating the offer price, in real-time, based at least in part on a change in market conditions.

Clause 10: The method of Clause 9, wherein a change in market conditions causes a change in the forecasted RTLMP.

Clause 11: The method of Clause 8, wherein the one or more agreement parameters comprise a power purchase agreement (PPA) value and a production tax credit (PTC) value.

Clause 12: The method of Clause 8, wherein the offer price is further configured to prevent a basis risk greater than a sum of values of the one or more agreement parameters if the offer price does not clear the market price.

Clause 13: A system comprising: one or more processors; memory comprising instructions that when executed by the one or more processors, cause the one or more processors to: determine a forecasted real-time locational marginal price (RTLMP) for an energy generation site; generate an offer price for sale of electricity generated by the energy generation site, the offer price based at least in part on the forecasted RTLMP and one or more agreement parameters, wherein the offer price is configured to reduce a basis risk if the offer price clears a market price; and post the offer price in an offer portal.

Clause 14: The system of Clause 13, wherein the forecasted RTLMP for an energy generation site can be determined, at least in part, by determining a forecasted RTLMP for a hub of the energy generation site.

Clause 15: The system of Clause 13, wherein the one or more agreement parameters comprise a power purchase agreement (PPA) value, a production tax credit (PTC) value, or any combination thereof.

Clause 16: The system of Clause 13, wherein the offer price is generated further based at least in part on a floor price and a ceiling price.

Clause 17: The system of Clause 13, wherein the offer price is generated via a formula comprising: Offer Price=Min((Max (P_{floor}, P_{Hub FX})−PPA−PTC),Offer Limit wherein P_{floor} is a floor price, P_{Hub FX} is the forecasted RTLMP, PPA is a power purchase agreement value, PTC is production tax credit value, and Offer Limit is a ceiling price.

Clause 18: The system of Clause 13, wherein the offer price clears a market price only if a sum of the one or more agreement parameters is greater than the basis risk.

Clause 19: The system of Clause 13, wherein the offer price is generated such that the offer price clears a market price only if the basis risk is less than the one or more agreement parameters.

Clause 20: The system of Clause 13, wherein the instructions, when executed by the one or more processors, further cause the one or more processors to update the offer price in real-time based at least in part on an outcome of a previous offer price.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A method for generating variable offer prices for sale of electricity at energy generation sites comprising:
determining a forecasted real-time locational marginal price (RTLMP) for an energy generation site;
generating an offer price for sale of electricity generated by the energy generation site, the offer price based at least in part on the forecasted RTLMP and one or more agreement parameters, wherein the offer price is configured to reduce a basis risk if the offer price clears a market price; and
posting the offer price in an offer portal.

2. The method of claim 1, wherein determining the forecasted RTLMP for an energy generation site comprises determining a forecasted RTLMP for a hub of the energy generation site.

3. The method of claim 1, wherein the one or more agreement parameters comprise a power purchase agreement (PPA) value, a production tax credit (PTC) value, or any combination thereof.

4. The method of claim 1, wherein the offer price is generated further based at least in part on a floor price and a ceiling price.

5. The method of claim 1, wherein the offer price is generated via a formula comprising:
$$Offer Price = Min ( ( Max ( {P}_{floor} , {P}_{Hub FX} ) - PPA - PTC ) , Offer Limit ) ,$$
wherein P_{floor} is a floor price, P_{Hub FX} is the forecasted RTLMP, PPA is a power purchase agreement value, PTC is production tax credit value, and Offer Limit is a ceiling price.

6. The method of claim 1, wherein the offer price clears a market price only if a sum of the one or more agreement parameters is greater than the basis risk.

7. The method of claim 1, wherein the forecasted RTLMP is a first forecasted RTLMP, wherein the offer price is a first offer price, the method further comprising:
determining a second forecasted RTLMP, after a set time interval, for the energy generation site, the second RTLMP based, at least in part, on a change in market conditions;
generating a second offer price based on the second forecasted RTLMP and the one or more agreement parameters, such that the second offer price is configured to reduce a basis risk if the second offer price clears a market price; and
posting the second offer price, after the set time interval, in the offer portal.

8. A method comprising:
determining a forecasted real-time locational marginal price (RTLMP) for a hub of a renewable energy site;
generating an offer price based at least in part on the forecasted RTLMP and one or more agreement parameters such that the offer price is configured to clear a market price only if a basis risk is less than one or more agreement parameters; and
posting the offer price to an offer portal of a grid operator.

9. The method of claim 8, further comprising updating the offer price, in real-time, based at least in part on a change in market conditions.

10. The method of claim 9, wherein a change in market conditions causes a change in the forecasted RTLMP.

11. The method of claim 8, wherein the one or more agreement parameters comprise a power purchase agreement (PPA) value and a production tax credit (PTC) value.

12. The method of claim 8, wherein the offer price is further configured to prevent a basis risk greater than a sum of values of the one or more agreement parameters if the offer price does not clear the market price.

13. A system comprising:
one or more processors;
memory comprising instructions that when executed by the one or more processors, cause the one or more processors to:
determine a forecasted real-time locational marginal price (RTLMP) for an energy generation site;
generate an offer price for sale of electricity generated by the energy generation site, the offer price based at least in part on the forecasted RTLMP and one or more agreement parameters, wherein the offer price is configured to reduce a basis risk if the offer price clears a market price; and
post the offer price in an offer portal.

14. The system of claim 13, wherein the forecasted RTLMP for an energy generation site is determined, at least in part, by determining a forecasted RTLMP for a hub of the energy generation site.

15. The system of claim 13, wherein the one or more agreement parameters comprise a power purchase agreement (PPA) value, a production tax credit (PTC) value, or any combination thereof.

16. The system of claim 13, wherein the offer price is generated further based at least in part on a floor price and a ceiling price.

17. The system of claim 13, wherein the offer price is generated via a formula comprising:
$$Offer Price = Min ( ( Max ( {P}_{floor} , {P}_{Hub FX} ) - PPA - PTC ) , Offer Limit ) ,$$
wherein P_{floor} is a floor price, P_{Hub FX} is the forecasted RTLMP, PPA is a power purchase agreement value, PTC is production tax credit value, and Offer Limit is a ceiling price.

18. The system of claim 13, wherein the offer price clears a market price only if a sum of the one or more agreement parameters is greater than the basis risk.

19. The system of claim 13, wherein the offer price is generated such that the offer price clears a market price only if the basis risk is less than the one or more agreement parameters.

20. The system of claim 13, wherein the instructions, when executed by the one or more processors, further cause the one or more processors to update the offer price in real-time based at least in part on an outcome of a previous offer price.
